(19) United States
(12) Patent Application Publication
(10) Pub. No.: US 2006/0004936 A1
(43) Pub. Date: Jan. 5, 2006

(54) Bridge for enabling communication between a FIFO interface and a PL3 bus for a network processor and an I/O card

(75) Inventors: Jayagopal Karuppampalayam, Cupertino, CA (US); James B. Lappin JR., San Francisco, CA (US); Adote K. Messavussu, Hayward, CA (US)

Correspondence Address: DARBY & DARBY P.C., P.O. BOX 5257, NEW YORK, NY, 10150-6257, US

(73) Assignee: Nokia Inc., Irving, TX (US)

(21) Appl. No.: 10/881,854

(22) Filed: Jun. 30, 2004

(51) Int. Cl. G06F 13/10

(52) U.S. Cl. 710/62

(57) ABSTRACT

A bridge for converting a relatively high speed communication interfaces provided by a network processor into another type of relatively high speed interface that is supported by an I/O card in a network device. A proprietary high speed communication interface can be a first-in-first-out (FIFO) streaming data interface. The other type of high speed interface supported by an I/O card can be PL3, PL4, SPI 3, SPI 4, and the like. The network devices can include, routers, switches, firewalls, gateways, and the like. The bridge can be configured as an application specific integrated circuit (ASIC).

### FIELD OF THE INVENTION

The invention is directed to interfaces for network devices, and more particularly, to a bridge for enabling high speed communication between a network processor and an I/O card.

### BACKGROUND OF THE INVENTION

Over the last ten years, network devices have had to employ an ever increasing amount of resources to handle communication links with other nodes on a network and relatively complex communication protocols. To provide these additional resources, some network devices have significantly increased their memory and processing capacity (multi-processors, faster clock cycles, and the like). Other network devices have employed separate network processors to process most tasks associated with handling communication links and communication protocols. These network processors enable network devices to operate effectively in a large network with complex communication protocols without significantly increasing memory or processing capacity.

Some network processors can provide different interfaces with different capacities for communicating with the network device's input/output (I/O) cards. Typically, these I/O cards handle communications at the Media Access Control (MAC) layer and the layers below as identified in the “OSI model” for network communication. However, different types of interfaces may have different data carrying capacities and may not be widely supported by most I/O cards (often provided by third parties). In some cases, the capacity of the network processor can be under utilized because of the lack of support for a particular interface provided by the network processor.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1A illustrates a block diagram of an exemplary network device that implements a GMII interface for communicating with I/O cards;

FIG. 1B illustrates a block diagram of another exemplary network device that employs a PL3 interface for communicating with I/O cards;

FIG. 2 shows a transmit channel block diagram for an application specific integrated circuit (ASIC) that is configured as an exemplary FIFO interface to PL3 bus bridge;

FIG. 3 illustrates a receive channel block diagram for an application specific integrated circuit (ASIC) that is configured as an exemplary FIFO interface to PL3 bus bridge;

FIG. 4 shows a PHTA monitor component that provides flow control in the middle of transmitting a data packet for the one channel mode;

FIG. 5 illustrates a table for mapping PL3 control signals to FIFO codes;

FIG. 6 shows a Host interface for writing to the following registers;

FIG. 7 illustrates a table of configuration registers for the exemplary bridge;

FIG. 8 shows a block diagram of a loop back mode at the PL3 interface;

FIG. 9 illustrates an overview of a block diagram for internally clocking the bridge at two different clock frequencies; and

FIG. 10 shows an overview of a block diagram of a process for handling translations between FIFO and PL3 interfaces in accordance with the invention.

### DETAILED DESCRIPTION OF THE INVENTION

The present invention is now described. While it is disclosed in its preferred form, the specific embodiments of the invention as disclosed herein and illustrated in the drawings are not to be considered in a limiting sense. Rather, these embodiments are provided so that this disclosure will be thorough and complete, and will fully convey the scope of the invention to those skilled in the art. Indeed, it should be readily apparent in view of the present description that the invention may be modified in numerous ways. Among other things, the present invention may be embodied as devices, methods, software, and so on. Accordingly, the present invention may take the form of an entirely hardware embodiment, an entirely software embodiment or an embodiment combining software and hardware aspects. The following detailed description is, therefore, not to be taken in a limiting sense.

Briefly stated, the invention is directed to an apparatus (bridge) that enables a relatively high speed communication interface that is provided by a network processor to be converted into another type of relatively high speed communication interface that is generally supportable by an I/O card in a network device. The high speed communication interface provided by the network processor is typically a first-in-first-out (FIFO) streaming data interface. The other type of high speed interface that is generally supported by I/O cards is a PLX bus, including, but not limited to, POS-Phy Level 3 (PL3), POS-Phy Level 4 (PL4), SPI 3, SPI 4, and the like. The network devices can include, routers, base stations, access nodes, switches, firewalls, gateways, and the like.

In one embodiment, the I/O card is configured as an Ethernet card that provides support for a plurality of communication links on a network. In one embodiment, the I/O card is configured to support a Gigabit Media Independent Interface (GMII) provided by the network processor; and in another embodiment, the I/O card is configured to support a PLX Interface.

In yet another embodiment, the bridge is configured as an application specific integrated circuit (ASIC) such as an FPGA, and the like, that is provided to the network device in addition to a network processor that substantially handles the processing of communication links. In one embodiment, the network processor's relatively high speed communication interface operates at a clock speed that is substantially greater than the I/O card's other relatively high speed communication interface, e.g., the FIFO interface could be clocked at approximately 200 MegaHertz and the PLX interface could be clocked at approximately 100 MegaHertz.

In still another embodiment, another apparatus is provided to enable the bridge to communicate with the I/O card over the other type of high speed interface, e.g., PLX, at the MAC layer. This other apparatus can be arranged as a separate ASIC that is provided in addition to the I/O card, or it can be integrated with at least one of the other I/O card components to convert PLX signals into those signals suitable for handling at the MAC layer.

Illustrative Operating Environment

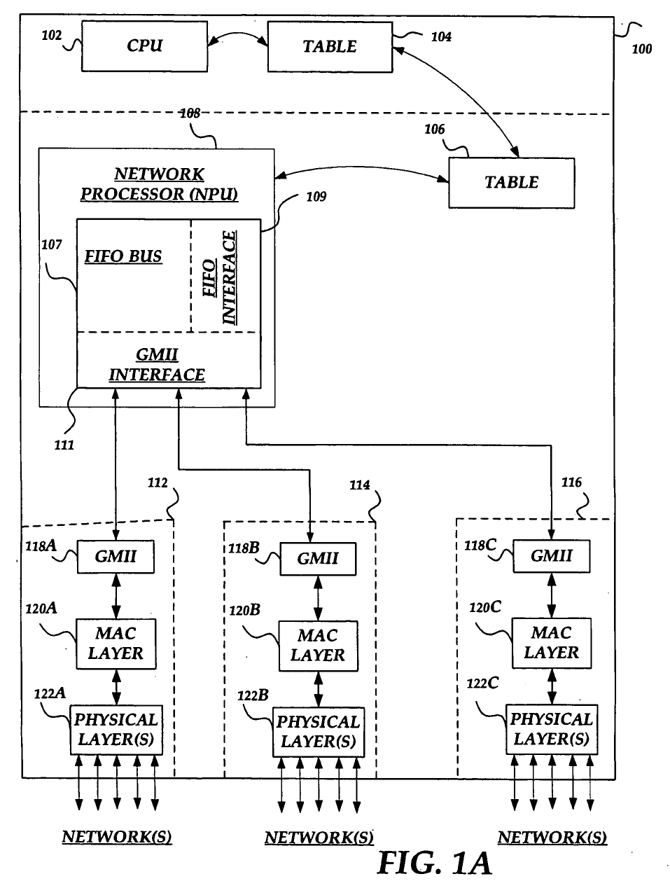

FIG. 1A illustrates a block diagram generally showing components included in network device 100 that are configured to employ the GMII interface to communicate over a network. The network device includes central processing unit (CPU) 102 and table 104 where the table includes a listing of information regarding communication links. Although other components for handling the general operation of the network device are not shown, they can also include Read Only Memory (ROM), Random Access Memory (RAM), power supply, flash memory, hard disk, pointing device interface, keyboard interface, software applications, and the like. In one embodiment, network processor 108 may be provided by the Broadcom corporation, such as part no. BCM 1250.

Network device 100 includes network processor (NPU) 108 which includes FIFO bus 110 for communicating over one of two interfaces with I/O cards 112, 114 and 116. GMII interface 111 converts the FIFO bus signals into GMII signals for communicating at substantially 1 gigabits per second with I/O cards 112, 114, and 116. Although not used in this embodiment, FIFO interface 109 is provided for converting the signals on the FIFO bus into a relatively “raw” data stream on the FIFO interface at a substantially higher rate than the GMII interface, e.g., 3.2 gigabits per second instead of 1.0 gigabits per second.

Each of I/O cards 112, 114 and 116 include integrated components 118A, 118B, and 118C, respectively, for converting communication with GMII interface 111 into signals that can be handled at the MAC layer. Each of the I/O cards include respective components 120A, 120B, and 120C for processing MAC layer signals. Additionally, each of the I/O cards include components 122A, 122B, and 122C for processing physical layer signals (magnetics, electrical signals, and the like). In one embodiment, the I/O cards provide physical Ethernet interfaces to an internal network. In another embodiment, the I/O cards can provide other types of interfaces to internal and/or external networks. Also, the component for converting communication with the GMII interface into the MAC layer can be provided separately and not integrated with the I/O cards 112, 114, and 116.

FIG. 1B illustrates a block diagram generally showing components included in network device 130 that are configured to employ FIFO interface 109 to communicate over a network. Network device 130 is arranged in ways that are substantially similar to network device 100 as shown in FIG. 1A, albeit differently arranged in other ways.

FIFO interface 109 is in communication with bridge 132 which employs components 134 and 136 to convert/translate the signals from FIFO interface 109 (and clock speed) into other signals (and another clock speed) that are PLX compliant. Components 134 and 136 are coupled to and in communication with respective I/O cards 138 and 140. The FIFO interface provides a relatively “raw” data stream in a relatively proprietary FIFO format that bridge 132 is adapted to recognize. Bridge 132 bi-directionally provides translation/conversion between the relatively proprietary FIFO data stream and the relatively well known high speed PLX data signals.

Each of I/O cards 138 and 140, include integrated components 142A and 142B, respectively, for bi-directionally handling the communication of signals with bridge 132. These components also convert PLX signals into signals that can be handled at the MAC layer. Each of the I/O cards include respective components 144A, and 144B for processing MAC layer signals. Additionally, each of the I/O cards include components 146A and 146B for processing physical layer signals (magnetics, electrical signals, and the like). In one embodiment, the I/O cards provide physical Ethernet interfaces to an internal network. In another embodiment, the I/O cards can provide other types of interfaces to internal and/or external networks. Also, the component for handling PLX communication with bridge 132 can be provided separately and not integrated with the I/O card.

Typically, NPU 108 provides either three GMII ports for handling 3×2=6 Gigabits full duplex or two FIFO interfaces (16 bit 200 MHz) providing a total 2×2×3.2=12.8 Gigabits full duplex. Bridge 132 can convert these two FIFO interfaces into two PLX interfaces, such as PL3, so that a maximum of six GMII devices can be connected, and thereby doubling connectivity.

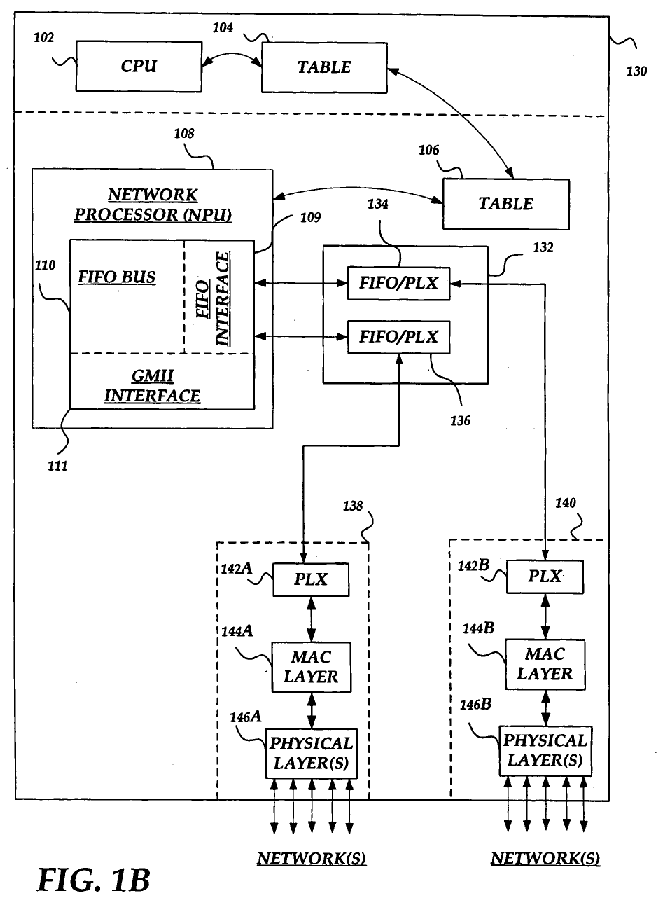

FIG. 2 illustrates a transmit channel block diagram for an application specific integrated circuit (ASIC) that is configured as an exemplary FIFO interface to PL3 bus bridge. There are four Dual clock fifos (dcfifo) instantiated in the ASIC. Two of the four dcfifos are transmit data dcfifos that are dedicated to the data bus TXD[15:0], while the other two transmit command dcfifos that are employed to store FIFO interface commands on TXC[2:0].

The transmit data dcfifo's dedicated to the data bus are 16 bits wide and 16 words deep. In comparison, the transmit command dcfifo's are 16 words deep, but only 3-bit wide. These transmit data dcfifo's act as circular buffers, which can be written to at different clocks speeds, e.g., 208 MegaHertz for writing to and 104 MegaHertz for reading from. A “write” into a transmit data dcfifo is initiated by a data valid command on the TXC input. If the TXC command indicates a valid data on TXD [15:0], the transmit data dcfifo control generates a write enable to the transmit data dcfifos. If the transmit data dcfifos have free blocks, the latched TXD data gets written into the transmit data dcfifos.

However, if the transmit data dcfifos are full (no free blocks), a FIFO FLO control component will assert a TXFC signal to the network processor to flow control (pause) subsequent data transmission. Once the contents of the PL3 bus is empty, the TXFC signal is de-asserted to the network processor, so that the transmission of data can be resumed. However, as data is read out of the dcfifo, it is qualified with the dcfifo's empty signal to ensure that the dcfifo is not read when empty.

For the PL3 bus transmit interface to transfer data to an I/O card or module, it first generates a read enable signal and then reads the contents of the two transmit data dcfifos. Typically, this read enable signal is continuously generated as long as the transmit data dcfifos do not indicate a buffer empty condition. With each read enable, one 16-bit word is read out of each transmit data dcfifo and one 3-bit command is read out of each command transmit dcfifo. The two 16-bit words are combined to form the 32-bit data (word) presented on the PL3 bus/interface, and the two 3-bit commands are combined at the PL3 Control Signals Generator and decoded to generate the appropriate PL3 bus signaling and a TMOD[1:0] signal for the last DWord transfer (transmitted data word).

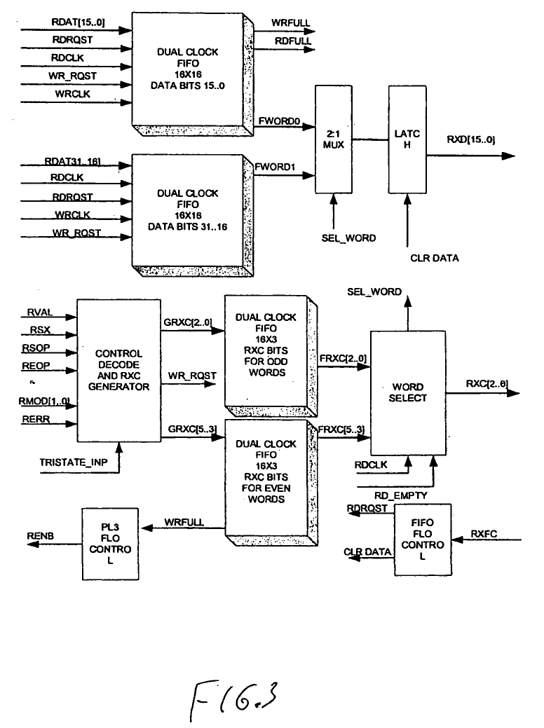

FIG. 4 illustrates a PHTA monitor component that provides flow control in the middle of transmitting a data packet for the one channel mode. The STPA signal is used for flow control in the PHY (physical) device. However, if a multi-channel mode is employed, flow control in mid-packet may be optionally employed.

Additionally, the data transmit interfaces also poll the PHY device channels for their status. The polled PTPA's information is updated into the PTPA configuration register and an interrupt is generated if there is any change in the PTPA registers. Typically, this polling is done if the number of channels register indicates a number greater than 0.

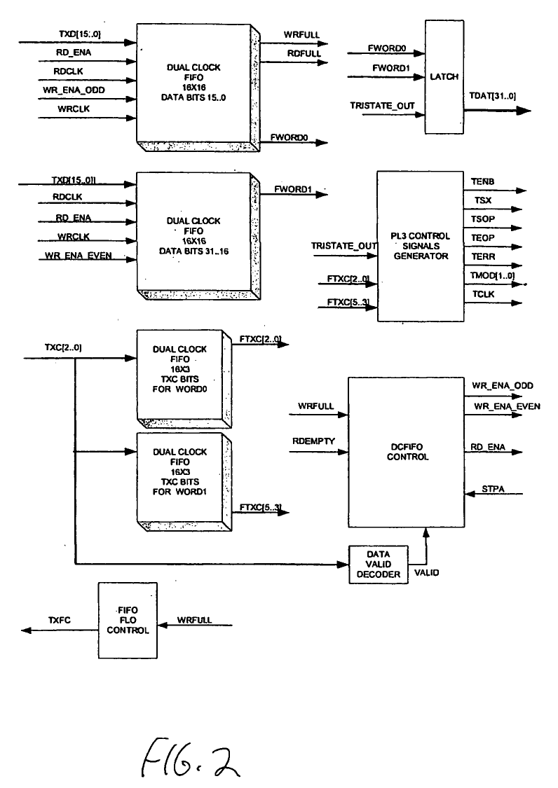

FIG. 3 illustrates a receive channel block diagram for an application specific integrated circuit (ASIC) that is configured as an exemplary FIFO interface to PL3 bus bridge. In this embodiment, two receive data dcfifo's, 16 bits wide and 16 words deep each, are used to hold the lower word (bits 15 to 0) and the upper word (bits 31 to 16) of the Rxdata signal as received from a Receive PL3 bus/interface.

Also, two receive control dcfifo's, 3 bits wide and 16 words deep each, are employed to hold the generated commands RXC[2:0] for the network processor's FIFO interface. Typically, these commands are generated using the control signal states on the PL3 Receive bus. The PL3 control signals include RVAL, RSX, RSOP, REOP, RMOD and RERR, which are subsequently fed to a Control Decode and RXC generator component. This component controls writes into the receive control dcfifo's and also generates the RXC[2:0] control codes for the FIFO interface.

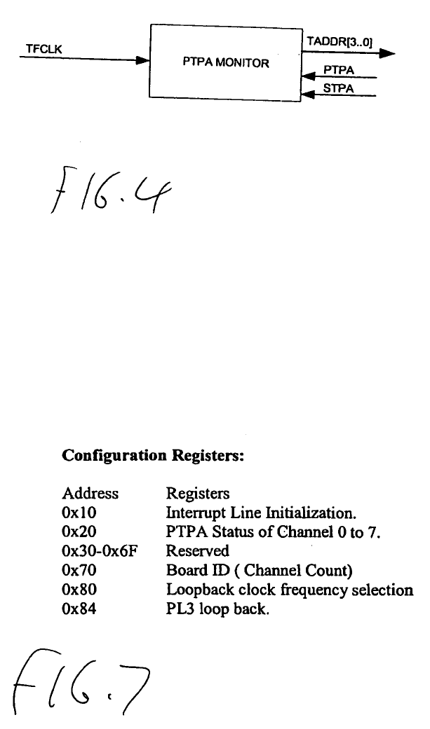

FIG. 5 illustrates a table for the mapping of the PL3 control signals and FIFO codes. As shown in the figure, a 3 bit code for each word gets written into one of the odd or even receive control dcfifo's. A PL3 Flo Control component also controls the write enables for the receive data dcfifos. Write enables are active for valid data (RVAL and RENB signals active), which come after an RSOP signal and until an REOP signal is received. The in-band address, which is accompanied by RSX is also treated as valid 32 bit data and written to the receive data dcfifos. An application is employed to decode the actual addresses for the data.

The latching of received data continues until an REOP signal is received at which time the RMOD signal is monitored to check the number of valid bytes in the last 32 bits of data. The 32 bit data is written into the receive data dcfifos, and the RXC control code is generated to indicate the validity/invalidity of the bytes on the FIFO interface for every word. The REOP signal indicate the end of a packet and writing halts until another RSX signal is received. If the ASIC samples an asserted RERR signal at REOP, an EOP signal with ERROR is written into the FIFO control code.

The PL3 Flo Control component achieves flow control by asserting RENB whenever the receive data dcfifos report a full condition. These dcfifos get written into using a receive clock (RFCLK) from the PL3 interface. However, reading from the FIFO interface employs an RCLK signal from the FIFO interface. The receiving process continues until the receive data dcfifos are empty. Once the receive data dcfifos empty condition is reached, the ASIC continues to send all zeros in the data lines as well as the RXC lines. The zeros on the RXC lines indicate invalid data, which would be ignored at the receiving end. Additionally, whenever the flow control request RXFC signal is asserted, the receive data dcfifos' read requests would be stopped and zeros would be sent to indicate invalid data.

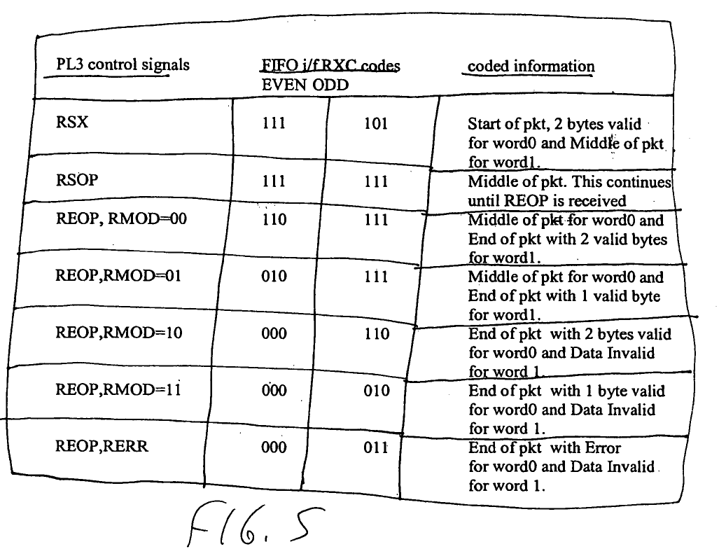

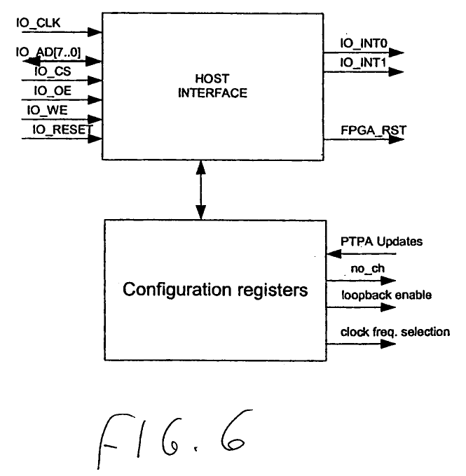

FIG. 6 illustrates a Host interface for writing to registers, including: Interrupt Line Initialization, PTPA Status of Channel 0 to 7, Loopback clock frequency selection, and PL3 loop back. The host interface enables configuration of the bridge by the network processor and provides the status of the bridge. Also, the host interface can read from substantially any of the other registers of the exemplary bridge. Additionally, FIG. 7 illustrates a table of configuration registers for the exemplary bridge.

The Interrupt Line Initialization register contains seven bits where bits 0 and 1 are used to signal interrupts due to changes in the PTPA Status registers. The zero (0) Bit is used for PTPA information from channels 0-7 and the one (1) Bit is employed for channels 8-16.

The PTPA Status of Channels 0 to 7 register is an 8-bit register that is employed to record the status of each PHY channel's PTPA signal. The status of the PTPA signal is obtained through a polling of the channels via the TADR[3:0] signals on the PL3 transmit interface.

The Board ID Register includes the number channels strapping information on the I/O card. This register is employed for the correct generation and interpretation of PL3 signaling on the PL3 interface.

The Loopback clock frequency selection register has a lower nibble that is written by software to indicate the frequency of the reference clock for loopback mode.

The PL3 Loop Back register is eight bit and the least significant bit (LSBit) is written by software to indicate the loopback mode. When enabled, the Transmit data path is directed to the Receive side at the PL3 interface.

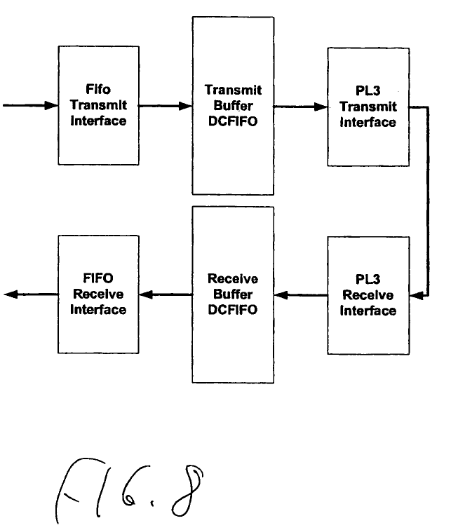

FIG. 8 illustrates a block diagram of a loop back mode at the PL3 interface. Typically, the loop back mode is employed for testing and during manufacturing. The loop back mode can be initiated through the host interface registers. The loop back mode provides testing of the FIFO to PL3 ASIC without having to include an actual 1/O card. In loop back mode, the Receive section will be clocked by the PL3 Transmit clock, which is fed back into the ASIC via a quick-switch (or tri-stateable zero delay buffer). Also, when in loopback mode, the ASIC outputs the frequency select signals to the clock buffer for clock frequency selection. “Hot” swapping of I/O cards is enabled by the invention. A tristate enable input, TEN, from the “hotswappable” ASIC is employed to tristate the PL3 transmit/receive buffers and control lines. The host interface and its registers are maintained, until software decides to reset the ASIC. During hotswap, data may be lost since the I/O module is no longer physically present. However, once an I/O card is plugged back in, software is employed to reset the ASIC.

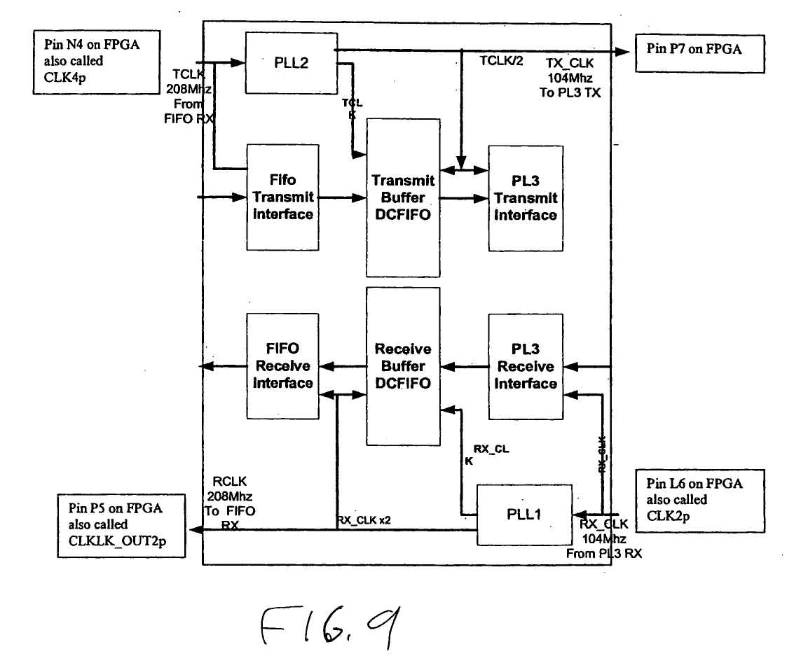

FIG. 9 illustrates an overview of a block diagram for internally clocking the bridge at two different clock frequencies. An integrated circuit that includes two phase locked loops (PLLs) such as those included in Part No. EP200KCF484 (Altera), and the like, may be employed to provide the different clock frequencies. In one embodiment, a dedicated clock output pin is employed to clock a 208 Mhz RCLK signal at the network processor to receive data on the FIFO interface and a regular I/O pin is employed to drive a 104 Mhz TX CLK for the PL3 transmit interface.

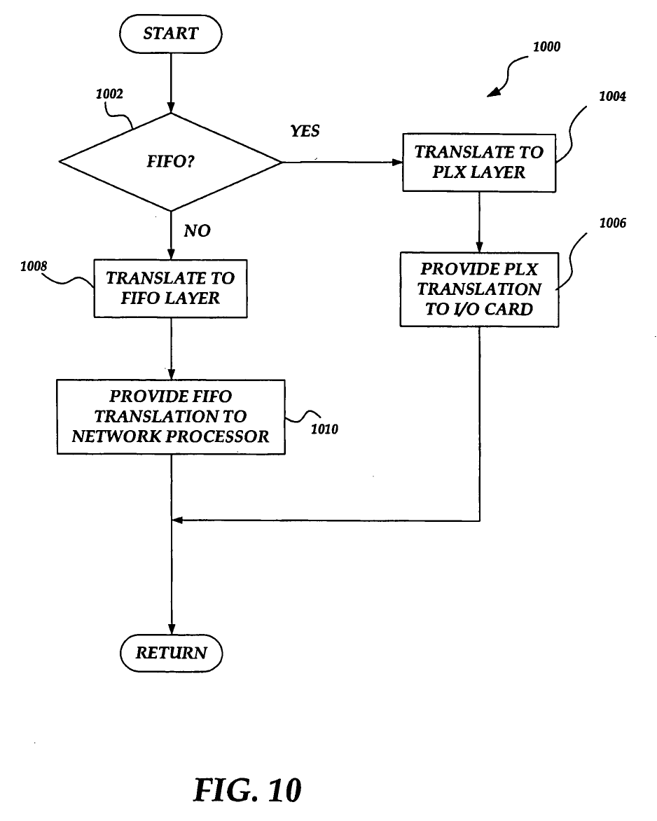

FIG. 10 shows an overview of a block diagram of a process for handling translations between FIFO and PLX interfaces. Moving from a start block, the process steps to block 1002 where a determination is made as to whether or not the received signals are from a FIFO interface. If true, the process advances to block 1004 where the received signals are translated into PLX signals. At block 1006, the PLX signals are provided to an I/O card for further processing at the MAC layer of a link on a network. Next, the process returns to performing other actions.

However, if the determination at decision block 1002 was negative, the process would advance to block 1008 where the received signals are translated into FIFO signals. At block 1010, the FIFO signals are provided to a network processor (NP) for further processing of a link on a network. Next, the process returns to performing other actions.

Moreover, it will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. An apparatus for enabling high speed communication between components in a network device, comprising:
a network processor having a proprietary high speed FIFO interface for communicating streaming data regarding at least one link on a network;
a bridge for bi-directionally converting the streaming data from the proprietary high speed FIFO interface into data signals based on a PLX format; and
an I/O card that is in communication with the network processor through the data signals provided in the PLX format.

2. The apparatus of claim 1, further comprising a component that converts data signals in the PLX iformat into other signals at the MAC layer for processing by the I/O card.

3. The apparatus of claim 2, wherein at least a portion of the component is integrated with the I/O card.

4. The apparatus of claim 2, wherein the component is disposed separate from the I/O card.

5. The apparatus of claim 1, wherein the bridge provides for bi-directionally converting a clock speed associated with the FIFO interface's data stream into another clock speed associated with the PLX formatted data signals.

6. The apparatus of claim 1, wherein the network is at least one of an external network and an internal network.

7. The apparatus of claim 1, wherein the I/O card provides an Ethernet interface for communicating over the network.

8. The apparatus of claim 1, wherein the PLX format is at least one of PL 3, PL 4, SPI 3, and SPI 4.

9. A bridge module for enabling high speed communication within a network device, comprising:
an interface that is configured for handling a data stream communicated over a FIFO interface provided by a network processor that provides information regarding at least one link on a network;
another interface that is configured for handling data signals communicated over a PLX interface associated with an I/O card; and
a converter that is arranged for bi-directionally converting a data stream associated with the FIFO interface into data signals arranged in the PLX format.

10. The bridge module of claim 9, wherein the PLX format is at least one of PL 3, PL 4, SPI 3, and SPI 4.

11. The bridge module of claim 9, wherein the bridge module is at least partially arranged in an application specific integrated circuit (ASIC).

12. The bridge module of claim 9, wherein the network processor further comprises a GMII interface for providing information regarding at least one link on the network.

13. The bridge module of claim 9, further comprising another component that provides for bi-directionally converting a clock speed associated with the FIFO interface's data stream into another clock speed associated with the PLX data signals.

14. The bridge module of claim 9, further comprising an interface for communicating with another component that converts data signals in the PLX format into other signals at the MAC layer for processing by the I/O card.

15. A method for enabling high speed communication between components in a network device, comprising:
if a data stream is received in a proprietary high speed FIFO format, converting this data stream into data signals based on a PLX format and providing these data signals to an I/O card; and
if data signals in the PLX format are received, converting these data signals into another data stream in the proprietary high speed FIFO format and providing this other data stream to a network processor.

16. The method of claim 15, further comprising converting a clock speed associated with the data stream in the FIFO format into another clock speed associated with the data signals in the PLX format.

17. The method of claim 15, further comprising converting the clock speed associated with the data signals in the PLX format into the clock speed associated with the data stream in the FIFO format.

18. The method of claim 15, wherein the PLX format is at least one of PL 3, PL 4, SPI 3, and SPI 4.

19. The method of claim 15, further comprising converting data signals in the PLX format into other signals at the MAC layer for processing by the I/O card.

20. An apparatus for enabling high speed communication between components in a network device, comprising:
a means for communicating with an I/O card through a data stream in proprietary high speed FIFO format regarding at least one link on a network;
a means for communicating with a network processor through data signals provided in the PLX interface regarding at least one link on a network; and
a means for bi-directionally converting the streaming data from the proprietary high speed FIFO interface into data signals based on the PLX format.
